(19) United States
(12) Patent Application Publication
(10) Pub. No.: US 2021/0107786 A1
(43) Pub. Date: Apr. 15, 2021

(54) PROCESS FOR THE PREPARATION OF SYNGAS

(71) Applicant: SHELL OIL COMPANY, HOUSTON, TX (US)

(72) Inventors: Ronald Jan SCHOONEBEEK, Amsterdam (NL); Robert SCHOUWENAAR, Amsterdam (NL); Ruben SMIT, Amsterdam (NL); Gerald SPRACHMANN, Amsterdam (NL)

(21) Appl. No.: 16/644,399

(22) PCT Filed: Sep. 4, 2018
(86) PCT No.: PCT/EP2018/073772

§ 371 Date: Mar. 4, 2020

(30) Foreign Application Priority Data
Sep. 6, 2017 (EP) 17189616.0

(51) Int. Cl. C01B 3/36; C01B 3/38; C10K 3/02; C10K 1/02

(52) U.S. Cl. CPC C01B 3/36; C01B 3/382; C10K 3/026; C10K 1/024; C01B 2203/0233; C01B 2203/049; C01B 2203/1241; C01B 2203/142; C01B 2203/1614; C01B 2203/1064; C01B 2203/1082; C01B 2203/0255

(57) ABSTRACT

A process for preparing a syngas from a methane comprising gas includes reacting the methane comprising gas with an oxidising gas at an operating temperature in the range of 1150 to 1370° C. by means of non-catalytic partial oxidation. A hot raw syngas mixture having a methane content higher than the methane content in a state of thermodynamic equilibrium at the operating temperature applied is passed through a bed of methane oxidation catalyst for oxidising methane with steam formed in the non-catalytic POX into carbon monoxide and hydrogen. The methane oxidation catalyst has at least one catalytically active metal supported on a refractory oxide support material where soot particles present in the hot raw syngas mixture are retained. The retained soot particles are converted to carbon monoxide. Soot depleted syngas is recovered in a state of thermodynamic equilibrium.

### FIELD OF THE INVENTION

The present invention relates to a process for the preparation of a syngas comprising hydrogen and carbon monoxide.

### BACKGROUND OF THE INVENTION

The expression “syngas” as used herein refers to synthesis gas, which is a common term to refer to gas mixtures comprising carbon monoxide and hydrogen.

Processes for the preparation of syngas from a methane comprising gas are well known. Typically, such process comprises reacting the methane comprising gas with an oxidising gas, generally oxygen or an oxygen-containing gas such as air. The methane reacts with the oxygen to form carbon monoxide and hydrogen. This reaction for producing syngas is commonly referred to as partial oxidation (POX) of methane.

The POX process is typically carried out in a partial oxidation reactor. This can be a catalytic or non-catalytic POX process. This invention focuses on non-catalytic POX processes. In such non-catalytic POX process the partial oxidation reactor typically comprises a burner placed at the top in a reactor vessel with a refractory lining. The reactants are introduced at the top of the reactor through the burner. In the reactor, the methane comprising feed gas reacts with the oxygen or oxygen-containing gas to form a syngas.

Non-catalytic POX processes are well known. The reaction between the methane in the feed and the oxygen that are fed to the reactor through the burner at the top typically takes place at temperatures between 1250 and 1400° C. and pressures above 30 bara to form carbon monoxide and hydrogen. The pressure will usually not exceed 70 bara and suitably will be between 35 and 65 bara. The raw syngas formed will, in addition to carbon monoxide and hydrogen, also comprise other components. Such other components would typically include soot, steam, carbon dioxide, nitrogen and possibly hydrogen sulphide. The raw syngas will typically also contain some unconverted methane. Several of these components may be formed in the POX process (soot, steam, carbon dioxide). Other components (nitrogen, hydrogen sulphide) and carbon dioxide may be present in the original methane comprising feed (e.g. natural gas) and/or originate from streams recycled to the methane comprising feed. For example, in a gas-to-liquids process part of the off-gas from the Fischer-Tropsch section may be recycled to the feed to the POX process. Such off-gas contains carbon dioxide and lower alkanes.

The raw syngas formed in the POX process is cooled, usually in multiple stages, for effective heat recovery purposes.

The non-catalytic POX process should be carried out at such temperature that a sufficiently high methane conversion into carbon monoxide and hydrogen is achieved. Within the aforesaid temperature range of 1250 to 1400° C., that would imply that the actual reaction temperature is usually at the higher end, i.e. 1340-1370° C. Operating at a lower temperature is possible and has certain advantages, such as a reduction in natural gas and oxygen consumption. This means that at a fixed oxygen consumption syngas make could potentially be increased at such lower operating temperature. A lower operating temperature also reduces carbon dioxide content in the syngas formed. However, disadvantages of a lower operating temperature would be more soot make and lower conversion of methane that would be expected at thermodynamic equilibrium, resulting in a higher methane slip and hence a higher methane content in the raw syngas formed. The methane content in syngas from a non-catalytic POX at lower operating temperature increases exponentially.

Removal of soot in a POX process, thereby allowing lower operating temperatures, is disclosed in US-2009/0224209-A1. In the POX process disclosed herein soot particles are captured in a ceramic foam filter or a ceramic wall-flow filter, where the retained soot particles are converted to carbon oxides, including carbon monoxide, at elevated temperature. US-2009/0224209-A1 is however, silent about methane slip and how to mitigate this.

The present invention aims to maximize syngas production at minimal use of methane comprising feed with minimal soot and inerts (methane, carbon dioxide) concentration in the syngas at any given operating temperature in the range of 1150 to 1370° C. Furthermore, the present invention aims to enable to operate at lower temperatures whilst still maintaining low soot and inerts concentration in the syngas at minimal use of methane comprising feed and optimal syngas production.

### SUMMARY OF THE INVENTION

The present invention relates to a process for the preparation of a syngas comprising hydrogen and carbon monoxide from a methane comprising gas by reacting the methane comprising gas with an oxidising gas at a temperature in the range of 1150 to 1370° C. resulting in a hot raw syngas mixture and subsequently contacting this hot raw syngas mixture with a methane oxidation catalyst that comprises at least one catalytically active metal supported on a refractory oxide support material where soot particles present in the hot raw syngas mixture are retained and converted into carbon monoxide, while the methane in the raw syngas mixture is oxidised into carbon monoxide and hydrogen. It was found that this combination of a non-catalysed POX reaction followed by a catalysed methane oxidation results in a raw syngas mixture that is in a state of thermodynamic equilibrium, thereby maximizing syngas production at minimal use of methane comprising feed with minimal soot and inerts (methane, carbon dioxide) concentration in the syngas at any given operating temperature in the range of 1150 to 1350° C. Producing a raw syngas at thermodynamic equilibrium also allows operation at lower temperatures whilst having an optimal balance between minimal use of methane comprising feed, maximum syngas production and minimal inert concentration in the syngas eventually recovered.

### DETAILED DESCRIPTION OF THE INVENTION

The present invention relates to a process for the preparation of a syngas comprising hydrogen and carbon monoxide from a methane comprising gas, which process comprises the steps of:

Process for the preparation of a syngas comprising hydrogen and carbon monoxide from a methane comprising gas, which process comprises the steps of:
(a) reacting the methane comprising gas with an oxidising gas at an operating temperature in the range of 1150 to 1370° C. by means of non-catalytic POX resulting in a hot raw syngas mixture comprising carbon monoxide and hydrogen and having a methane content higher than the methane content in a state of thermodynamic equilibrium at the operating temperature applied;
(b) passing the hot raw syngas mixture resulting from step (a) through a bed of methane oxidation catalyst for oxidising methane with steam formed in the non-catalytic POX into carbon monoxide and hydrogen, which methane oxidation catalyst comprises at least one catalytically active metal supported on a refractory oxide support material where soot particles present in the hot raw syngas mixture resulting from step (a) are retained;
(c) converting the soot particles retained in the refractory oxide support material to carbon monoxide; and
(d) recovering soot-depleted syngas in a state of thermodynamic equilibrium.

The hot raw syngas mixture formed in step (a) is not in a state of thermodynamic equilibrium and, as a consequence, its methane content will be higher than would be the case if the hot raw syngas mixture would have been in such a state of thermodynamic equilibrium. Since the soot-depleted hot syngas eventually obtained in step (d) is in a state of thermodynamic equilibrium, the methane content of this soot-depleted hot syngas is lower than the methane content of the hot raw syngas obtained in step (a). This allows operating at lower temperatures, because the methane slip as well as the additional soot make at such lower operating temperatures are effectively dealt with by the measures taken resulting in the thermodynamic equilibrium state being reached at the given operating temperature. This also implies that operating at the higher end of the temperature range, i.e. from 1300 to 1350° C., will result in a methane content of the soot-depleted hot syngas obtained in step (d) of less than 0.5% v/v and closer to 0% v/v as the operating temperature is closer to 1350° C. At such higher temperatures namely, a gas mixture having a composition as formed in the POX process will have a methane content in a state of thermodynamic equilibrium which is close to 0% v/v.

In step (a) of the present process a methane comprising gas is reacted with an oxidising gas at a temperature in the range of 1150 to 1370° C. to obtain a hot raw syngas mixture by means of non-catalytic partial oxidation. The main reaction that takes place is:

CH₄+½₂→CO+2H₂

In this non-catalytic POX process all oxygen fed into the burner at the top of the POX reactor reacts in the reactor. Main reaction products are carbon monoxide and hydrogen, but other components, such as steam (H₂O), are also formed.

Examples of suitable methane comprising feeds include (coal bed) methane, natural gas, associated gas, refinery gas or a mixture of C1-C4 hydrocarbons. The methane comprising feed suitably comprises more than 90 v/v %, especially more than 94%, C1-C4 hydrocarbons and at least 60 v/v % methane, preferably at least 75 v/v %, more preferably at least 90 v/v %. Most preferably natural gas is used.

The oxidising gas used is oxygen or an oxygen-containing gas. Suitable gases include air (containing about 21 volume percent of oxygen) and oxygen enriched air, which may contain at least 60 volume percent oxygen, more suitably at least 80 volume percent and even at least 98 volume percent of oxygen. Such substantially pure oxygen is preferably obtained in a cryogenic air separation process or by so-called ion transport membrane processes.

As indicated above operating temperatures in step (a) are in the range of 1150 to 1370° C. Preferably, the operating temperature is in the range of 1250 to 1370° C. Operating pressures are typically between 30 and 70 bara and suitably between 35 and 65 bara. Preferably, most of the reforming reactions (POX reactions) take place above the catalyst bed—the unconverted CH4 from the non-catalytic POX reaction is reformed in the catalyst bed.

In step (b) the hot raw syngas mixture resulting from step (a) is passed through a bed of methane oxidation catalyst for oxidising methane into carbon monoxide and hydrogen. This methane oxidation catalyst comprises at least one catalytically active metal supported on a refractory oxide support material. This refractory oxide material should be capable of retaining the soot particles present in the hot raw syngas mixture resulting from step (a). Suitable methane oxidation catalysts are those catalysts that are able to withstand the high operating temperatures whilst effectively catalysing the methane oxidation reaction with steam (H₂O):

CH₄+H₂O→CO+3H₂

The steam that acts as the oxidising agent in this reaction is formed in the partial oxidation step (a). The methane reforming reaction on the catalyst bed uses H2O that is formed in the non-catalytic POX reaction. Suitable catalysts, accordingly, are those oxidation catalysts that comprise one or more catalytically active metals, such as rhodium, iridium, zirconium and/or cerium, supported on a refractory oxide material such as alumina or zirconia. The amount of each of the catalytically active metals will typically vary between 0.001 and 1.0 wt %, more suitably between 0.01 wt % and 0.5 wt %.

In one embodiment of the present invention the hot raw syngas mixture resulting from step (a) is first passed through a bed of a refractory oxide material before it is passed through a bed of the methane oxidation catalyst. The first bed of refractory oxide material will then capture most of the soot particles. Particularly at high soot contents of the hot raw syngas, this may be a feasible option. If such refractory oxide top-bed is used, it is preferred that the refractory oxide material of such top-bed is the same material as the refractory oxide support material of the methane oxidation catalyst.
Soot is formed in the burner of the non-catalytic POX process by the non-ideal mixing of natural gas feed and oxygen. The soot is not formed on the refractory oxide material. The soot, or part of the soot, is captured by the catalyst carrier. Soot is thermodynamically not favored at the foreseen reactor conditions, which means that under said conditions all soot that has been captured will also be gasified. The expected residence time of a soot particle is 3 minutes.

In step (c) the soot particles retained in the refractory oxide material are converted to carbon monoxide. Without wishing to be bound by any particular theory, the soot retained in the refractory oxide material is considered to be converted via following reactions:

C+CO₂→2CO

C+H₂O→CO+H₂

In this way the majority of the soot particles formed in the POX reaction will be converted, thereby not only preventing clogging of the channels in refractory oxide material and hence ensuring an unhindered flow of the hot raw syngas through the methane oxidation catalyst bed and possibly the refractory oxide bed on top thereof, but also preventing problems with other equipment, such as strippers, downstream of the POX reactor. A small part of the soot particles will be allowed to pass through the POX reactor, as these soot particles may form a protective layer on the inner wall of metal tubes in the downstream cooling equipment, thereby protecting those metal tubes against metal dusting and corrosion when exposed to the hot raw syngas.

In the process of the present invention steps (a), (b) and (c) are suitably carried out in a single POX reactor comprising a vertically elongated reactor vessel comprising a burner with inlet means for the methane comprising feed gas and the oxidising gas positioned at the top end of the vessel, outlet means for the soot-depleted syngas at the bottom end of the reactor vessel and a solids bed positioned inside the reactor vessel below the burner and above the outlet means, thereby dividing the reactor in an upper space and a lower space, wherein the solids bed comprises a bed of the methane oxidation catalyst. In a further preferred embodiment the solids bed comprises a bed of refractory oxide material capable of retaining soot particles positioned on top of a bed of the methane oxidation catalyst.

The solids bed could be mounted inside the reactor by means known in the art, for example, as described in US-2009/0224209-A1. Accordingly, the solids bed could be supported by a refractory brick support arch mounted to the inner wall of the POX reactor. Preferably, the exiting syngas temperature is above 1200° C., more preferably above 1250° C., even more preferably above 1280° C. The H2/CO ratio of the syngas as obtained in step (d) is preferably lower than 2. The present disclosure is not limited to the embodiments as described above and the appended claims. Many modifications are conceivable and features of respective embodiments may be combined.

The following examples of certain aspects of some embodiments are given to facilitate a better understanding of the present invention. In no way should these examples be read to limit, or define, the scope of the invention.

### Example

A synthesis gas representative for the synthesis gas obtained by non-catalytic partial oxidation of natural gas at 1250° C., having a composition as indicated in Table 1, was fed into an externally heated reactor and passed through a bed of methane oxidation catalyst contained in the reactor. The methane oxidation catalyst consisted of crushed alumina 8 millimeter rings having a particle size in the range of 2800 to 3350 micrometer and a metal loading of 0.05 wt % rhodium, 0.05 wt % iridium, 0.07 wt % zirconium and 0.19 wt % cerium.

Different operating temperatures were applied and the synthesis gas was passed through the catalyst bed for approximately 5 hours at each operating temperature applied. The outlet synthesis gas was continuously analysed and methane conversion was determined at those different operating temperatures.

### Comparative Example

The Example described above was repeated except that the catalyst bed contained in the externally heated reactor consisted of crushed alumina 8 millimeter rings having a particle size in the range of 2800 to 3350 micrometer only. So no metal loading was applied.

The results by way of average methane conversion measured at the operating temperatures applied are indicated in Table 2.

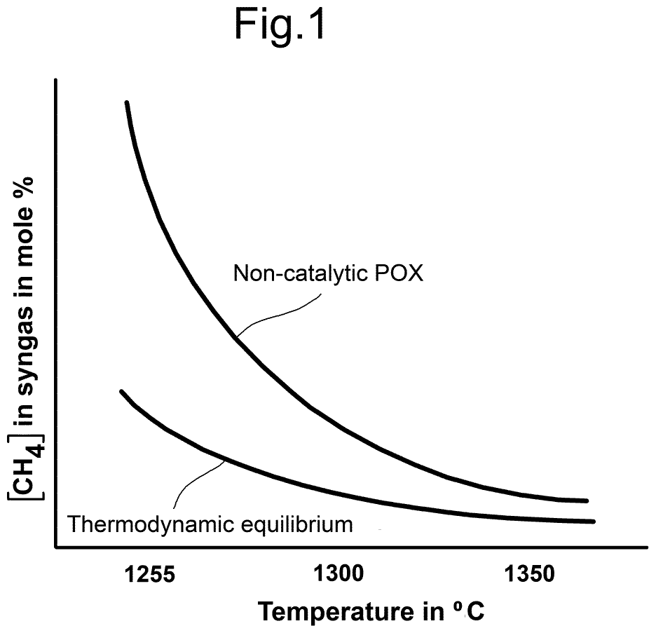

FIG. 1 shows that syngas from non-catalytic POX does not reach thermodynamic equilibrium for CH4 and in addition, the CH4 content in syngas increases exponentially at lower operating temperatures.

The optimal non-catalytic POX temperature for Fischer-Tropsch synthesis is partly defined by the CH4 and CO2 content in syngas. A high operating temperature gives higher CO2 and lower CH4 content; a low operating temperature gives the reverse effect. CH4 and CO2 are both inerts for the Fischer-Tropsch reactions. At thermodynamic equilibrium the CH4 content is lower compared to the non-catalytic POX, especially at lower operating temperatures. The optimal operating temperature for Fischer Tropsch application is lower when the syngas is at thermodynamic equilibrium compared to the syngas that has produced with non-catalytic POX. An infinitesimal large reactor is required to reach thermodynamic equilibrium in a non-catalytic POX

The catalyst shall bring the syngas from the non-catalytic POX to thermodynamic equilibrium. This enables operation at a lower temperature for the syngas production which results in a higher carbon efficiency of the Gas-to-liquids. Table 2 shows the methane conversion at thermodynamic equilibrium at the different operating temperatures applied as well as the average methane conversion measured at the same operating temperatures.

TABLE 1
Syngas composition

| Component | Amount | |
|---|---|---|
| H₂ | 53.8 | wt % |
| CO | 30.3 | wt % |
| CO₂ | 1.5 | wt % |
| N₂ | 1.2 | wt % |
| H₂O | 7.4 | wt % |
| CH₄ | 5.8 | wt % |
| H₂S | 1 | ppmv |

TABLE 2
Results

| Temperature (° C.) | | <CH₄ conv.> (%) |
|---|---|---|
| 1288 | Thermodynamic Equil. | 89 |
| | Example | 89 |
| | Comparative Example | 61 |
| 1238 | Thermodynamic Equil. | 83 |
| | Example | 83 |
| | Comparative Example | 30 |
| 1188 | Thermodynamic Equil. | 74 |
| | Example | 74 |
| | Comparative Example | 15 |

Table 2 shows that use of a methane oxidation catalyst in accordance with the process of the present invention effectively brings the synthesis gas resulting from a non-catalytic POX process to its thermodynamic equilibrium at the operating temperature applied and hence effectively deals with methane slip when carrying out a non-catalytic POX process at relatively lower operating temperatures.

1. A process for the preparation of a syngas comprising hydrogen and carbon monoxide from a methane comprising gas, which process comprises the steps of:
(a) reacting the methane comprising gas with an oxidising gas at an operating temperature in the range of 1150 to 1370° C. by means of non-catalytic partial oxidation resulting in a hot raw syngas mixture comprising carbon monoxide and hydrogen and having a methane content higher than the methane content in a state of thermodynamic equilibrium at the operating temperature applied;
(b) passing the hot raw syngas mixture resulting from step (a) through a bed of methane oxidation catalyst for oxidising methane with steam formed in the non-catalytic POX into carbon monoxide and hydrogen, which methane oxidation catalyst comprises at least one catalytically active metal supported on a refractory oxide support material where soot particles present in the hot raw syngas mixture resulting from step (a) are retained;
(c) converting the soot particles retained in the refractory oxide support material to carbon monoxide; and
(d) recovering soot-depleted syngas in a state of thermodynamic equilibrium.

2. The process according to claim 1, wherein step (a) is carried out at a temperature in the range of 1250 to 1370° C.

3. The process according to claim 1, wherein in step (b) the hot raw syngas mixture resulting from step (a) is first passed through a bed of a refractory oxide material before it is passed through a bed of the methane oxidation catalyst.

4. The process according to claim 3, wherein the refractory oxide material is the same material as the refractory oxide support material of the methane oxidation catalyst.

5. The process according to claim 1, wherein steps (a), (b) and (c) are carried out in a single reactor comprising a vertically elongated reactor vessel comprising a burner with inlet means for the methane comprising feed gas and the oxidising gas positioned at the top end of the vessel, outlet means for the soot-depleted syngas at the bottom end of the reactor vessel and a solids bed positioned inside the reactor vessel below the burner and above the outlet means, thereby dividing the reactor in an upper space and a lower space, wherein the solids bed comprises a bed of the methane oxidation catalyst.

6. The process according to claim 5, wherein the solids bed comprises a bed of refractory oxide material capable of retaining soot particles positioned on top of a bed of the methane oxidation catalyst.
